(19) United States
(12) Patent Application Publication
(10) Pub. No.: US 2020/0132473 A1
(43) Pub. Date: Apr. 30, 2020

(54) SYSTEMS AND METHODS FOR DETERMINING VEHICLE LOCATION IN PARKING STRUCTURES

(71) Applicant: Ford Global Technologies, LLC, Dearborn, MI (US)

(72) Inventors: Robert Shipley, Plymouth, MI (US); Erick Lavoie, Dearborn, MI (US)

(73) Assignee: Ford Global Technologies, LLC, Dearborn, MI (US)

(21) Appl. No.: 16/172,670

(22) Filed: Oct. 26, 2018

(51) Int. Cl. G01C 21/32; G01C 21/16; G01C 21/20; G01S 19/49; G07C 5/00

(52) U.S. Cl. CPC G01C 21/32; G01C 21/165; G07C 5/008; G01S 19/49; G01C 21/206

(57) ABSTRACT

Systems, methods, and computer-readable media are disclosed for determining vehicle location in parking structures. Example methods may include receiving, by one or more computer processors coupled to at least one memory, first data from one or more devices of a vehicle, the first data indicative of the vehicle being in a parking structure; receiving, second data from the one or more devices of the vehicle, the second data indicative of a landmark associated with the parking structure; determining, based on the second data, a feature of the landmark; and causing to transmit a signal indicative of information associated with the feature.

### TECHNICAL FIELD

The present disclosure relates to systems, methods, and computer-readable media for determining vehicle locations, and in particular, to determining vehicle location in parking structures.

### BACKGROUND

User may be interested in locating and tracking their vehicles, for example, prior to, during, and after navigation. In another embodiment, global navigation satellite systems may provide geolocation and time information to a global positioning system (GPS) receiver on the Earth where there is an unobstructed line of sight to four or more GPS satellites. However, obstacles such as mountains and buildings may block relatively weak GPS signals.

### BRIEF DESCRIPTION OF THE DRAWINGS

FIG. 1 shows a diagram of an environmental context for vehicle location determination, in accordance with example embodiments of the disclosure.

FIG. 2 shows a diagram of an example vehicle detecting landmarks while navigating a parking structure, in accordance with example embodiments of the disclosure.

FIG. 3 shows a diagram of a vehicle navigating a portion of a parking structure, in accordance with example embodiments of the disclosure.

FIG. 4 shows an example process flow for a method of vehicle location determination, in accordance with example embodiments of the disclosure.

FIG. 5A shows another example process flow for a method of vehicle location determination, in accordance with example embodiments of the disclosure.

FIG. 5B shows another example process flow for a method of vehicle location determination, in accordance with example embodiments of the disclosure.

FIG. 6 is a schematic illustration of an example autonomous vehicle, in accordance with one or more embodiments of the disclosure.

FIG. 7 is a schematic illustration of an example server architecture for one or more server(s), in accordance with one or more embodiments of the disclosure.

### DETAILED DESCRIPTION OF EXAMPLE EMBODIMENTS

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In urban settings, drivers of vehicles may use parking garages or parking lots to park their vehicles for access to various establishments and businesses. Moreover, merely storing a location (e.g., a GPS location) of the vehicle on a user device (e.g., a smart phone), may be insufficient in helping a user find their vehicle, as such location information may be incomplete or inaccurate. This may be due to a variety of reasons, including, but not limited to, the fact that GPS signals may be weak or inaccurate in enclosed areas such as certain parking structures. Accordingly, merely storing a GPS location may not be helpful in parking structures with multiple levels, for example, because the floor level may not be easily monitored and because the GPS signal may be poor in such closed structures, and also because such a GPS signal may not reveal the vertical dimension associated with the floor level of a parked vehicle. Additionally, merely accessing the vehicle's cameras remotely from a phone may provide a user with an immediate view of the car's surroundings; however, the vehicle's cameras may not be informative if it does not have a view of associated landmarks and signage that would help locate the vehicle in a crowded multi-level parking structure.

In various embodiments, the disclosure describes systems, methods, and apparatuses for determining an entry into a parking garage or structure, and for recording information that may be used to determine the location of a parked vehicle. In particular, in an embodiment, the vehicle may sense changes in a parking structure level using one or more sensors and devices on the vehicle, for example, wheel speed sensors, a steering angle sensor, inertial sensors, and the like to determine one or more of the following: pitch changes, turns, and/or position (via dead reckoning) of the vehicle, and use this information to determine (e.g., calculate or determine using one or more artificial-intelligence based algorithms) the location of the vehicle.

In another embodiment, alternatively or additionally, one or more pattern recognition algorithms may be used in association with data from originating from the vehicle's devices such as the vehicle's cameras, radio detection and ranging (radar), light detection and ranging (lidar), and/or ultrasound, in order to identify and store images of landmarks and features of the parking garage such as elevators, pillars, walls, structures in view of exterior openings and the like.

In one embodiment, one or more algorithms, for example, sign recognition and/or optical character recognition (OCR) algorithms may be used to recognize and read various features such as floor number and colors associated with signs in the parking structure, and/or to recognize and read features from paint marks on the ground and/or nearby walls (e.g., a parking space number). In particular, the system and the one or more algorithms may identify space numberings associated with nearby walls of a parking structure, and/or may identify floor numbering. Moreover, the algorithms may be used to determine when to store a picture of one or more signs (e.g., upon the determination of a given feature of a parking garage).

In one embodiment, one or more devices associated with the vehicle may be configured to transmit images to a user device (e.g., a mobile phone) while wirelessly connected to the user device. For example, the vehicle devices may be configured to transmit images of particular features of landmarks (e.g., those landmarks having a given features such as a number associated with floor number) and/or images captured within a particular time before the vehicle was parked.

In one embodiment, a vehicle park state may be determined from a signal (e.g., a state signal) provided by a software or hardware package installed on the vehicle, for example, a remote park assist (RePA), or other similar modules and/or software packages associated with the vehicle, which may be an autonomous vehicle. Alternatively or additionally, a vehicle park state may be determined from one or more computing modules that may have their power maintained after the vehicle is turned off by the user until the information is transmitted to a user device (e.g., a mobile phone).

In one embodiment, if the vehicle is unable to transmit the parking images and data to the phone upon parking, the user may be able to establish a an alternative communication with the vehicle (e.g., via a cellular or Wi-Fi data interface) in order for the user to access one or more images (e.g., landmark images) and/or parking structure level information (e.g., determined by one or more algorithms using the images or other data from devices on the vehicle) from the vehicle as available by using a user device.

In various aspects, one or more user devices associated with either the driver or passengers of the vehicle may include sensors that can be used to supplement information determined by the vehicle and associated devices. For example, in one embodiment, the vehicle may include a magnetometer or a barometer, in part, to determine an elevation or altitude of the vehicle. The vehicle and associated devices may employ sensor fusion to determine a parking activity. For example, a combination of sensor outputs may be analyzed by a computing module on the vehicle that simultaneously or successively indicate certain thresholds have been met to determine a parking activity.

In another aspect, the vehicle and associated devices (e.g., cameras, lidar, radar and the like) may determine a gate associated with entry to a parking garage. In another embodiment, the vehicle and associated devices may upload information and/or images to a cloud-based network. In one embodiment, the vehicle and associated devices, and/or one or more user devices (e.g., a driver device or a passenger device) may be configured to detect and communicate with an indoor positioning system (IPS), to be discussed further below.

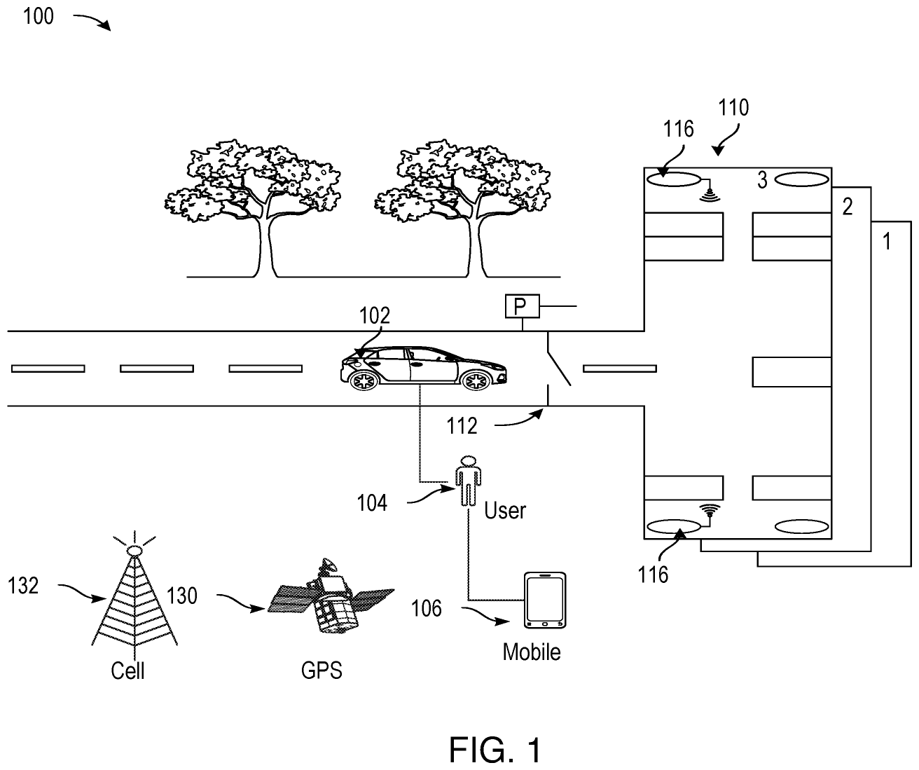

FIG. 1 shows a diagram of an environmental context for vehicle location determination, in accordance with example embodiments of the disclosure. Environmental context 100 may include a vehicle 102. The vehicle 102 may be associated with one or more users 104 (e.g., a driver and one or more passengers). In one embodiment, the users 104 may have user devices (e.g., mobile devices, tablets, laptops, and the like). In one embodiment, the vehicle 102 may be any suitable vehicle such as a motorcycle, car, truck, recreational vehicle (RV), boat, plane, etc., and may be equipped with suitable hardware and software that enables it to communicate over a network, such as a local area network (LAN).

In one embodiment, the vehicle 102 may include an autonomous vehicle (AV). In another embodiment, the vehicle 102 may include a variety of sensors that may aid the vehicle in navigation, such as radio detection and ranging (radar), light detection and ranging (lidar), cameras, magnetometers, ultrasound, barometers, and the like (to be described below). In one embodiment, the sensors and other devices of the vehicle 102 may communicate over one or more network connections. Examples of suitable network connections include a controller area network (CAN), a media-oriented system transfer (MOST), a local interconnection network (LIN), a cellular network, a WiFi network, and other appropriate connections such as those that conform with known standards and specifications (e.g., one or more Institute of Electrical and Electronics Engineers (IEEE) standards, and the like).

In one embodiment, the vehicle 102 may include one or more magnetic positioning devices such as magnetometers, which may offer an indoor location determination accuracy of 1-2 meters with 90% confidence level, without using additional wireless infrastructure for positioning. Magnetic positioning may be based on the iron inside buildings (e.g., parking structures 110) that create local variations in the Earth's magnetic field. Un-optimized compass chips inside devices in the vehicle 102 may sense and record these magnetic variations to map indoor locations, for example, a parking location within the parking structure 110. In one embodiment, the magnetic positioning devices may be used to determine the elevation of the vehicle 102 within the parking structure 110. Alternatively or additionally, a barometer device may be used to determine the elevation of the vehicle's 102 in the parking structure. In another embodiment, barometers and pressure altimeters may be a part of the vehicle and may measure pressure changes caused by a change in altitude of the vehicle 102.

In one embodiment, the vehicle 102 may use one or more inertial measurement devices (not shown) to determine the vehicle's position in the parking structure 110. The vehicle 102 may use dead reckoning and other approaches for positioning of the vehicle using an inertial measurement unit carried by the vehicle 102, sometimes referring to maps or other additional sensors to constrain the inherent sensor drift encountered with inertial navigation. In one embodiment, one or more microelectromechanical systems (MEMS) based inertial sensors may be used in the inertial measurement unit of the vehicle 102; however, the MEMS sensors may be effected by internal noises which may result in cubically growing position error with time. In one embodiment, to reduce the error growth in such devices, a Kalman filtering based approach may be used, by implementing software algorithms on software modules associated with the various devices in the vehicle 102. In another embodiment, the vehicle 102 and associated software modules may execute various algorithms to build a map of the parking structure 110 itself, for example, using a simultaneous localization and mapping (SLAM) algorithm framework.

In one embodiment, the inertial measurements may cover one or more differentials of motion of the vehicle 102, and therefore, the location may be determined by performing integration functions in the software modules, and accordingly, may require integration constants to provide results. Further, the position estimation for the vehicle 102 may be determined as the maximum of a two-dimensional or a three-dimensional probability distribution which may be recomputed at any time step, taking into account the noise model of all the sensors and devices involved and the constraints posed by walls of a parking structure 110 and other obstacles (e.g., other vehicles in the parking structure 110). Based on the vehicle's 102 motion, the inertial measurement devices may be able to estimate the vehicle's 102 locations by one or more artificial intelligence algorithms, for example, one or more machine learning algorithms (e.g., convolutional neural networks).

In another embodiment, the environmental context 100 may include a parking structure 110. In one embodiment, the parking structure 110 may include a multi-level parking garage. In another embodiment, the movement of vehicles between floors of the multi-level parking structure may take place by means of one or more of interior ramps, exterior ramps which may take the form of a circular ramp, vehicle lifts, and/or automated robot systems which may comprise a combination of ramp and elevator. In another embodiment, when the multi-level parking structure is built on sloping land, it may be split-level (e.g., having staggered levels) or it may have sloped parking.

In one embodiment, the parking structure 110 may include a gate 112, for example, an electric gate. The electric gate may refer to an entrance gate which can be opened and closed via an electric powered mechanism. In another embodiment, the vehicle 102 may include sound sensors (e.g., microphones, not shown) that may be used to detect one or more events such as inserting a credit card into an automated teller machine, buying a ticket, a gate 112 opening, and the like. Such events may be used to determine that a vehicle is entering the parking structure 110.

In another embodiment, the parking structure 110 may include a virtualized gate that comprises a digital and/or wireless gateway that may be activated upon entry detection using, for example, a GPS signal or a wireless signal of any suitable type. For example, the parking structure 110 may be a free parking structure that may not incorporate physical signs, tangible gates, and/or credit card readers and ticketing mechanisms. In such situations, embodiments of the disclosure may use any suitable feedback sensor (e.g., a sensor on the vehicle 102, a sensor on the user device 106, and the like) to ping the parking structure 110 upon entry. For example, the sensor may transmit and receive a signal (e.g., a radar signal, an ultrasound signal, and the like) to and from the physical structure of the parking structure 110 and/or to and from a device (not shown) associated with the parking structure 110, where the device includes a transceiver. Further, the sensor may send feedback to one or more additional devices of the vehicle 102 or the user device 106 to determine that the vehicle 102 is in a parking structure 110. Accordingly, embodiments of the disclosure may permit the identification of the entry of a vehicle 102 into parking structures 110 of any suitable type.

In one embodiment, the parking structure 110 may include one or more wireless communication devices 116. For example, the wireless communication devices 116 may include wireless access points (APs), Light fidelity (Li-Fi) devices (e.g., photodiodes, to be described below), indoor positioning devices (e.g., beacons), and the like.

In one embodiment, the positioning of the vehicle 102 in the parking structure 110 may be based on visual markers (not shown). In particular, a visual positioning system in the vehicle 102 (not shown) may be used to determine the location of a camera-enabled vehicle 102 by decoding location coordinates from one or more visual markers in the parking structure 110. In such a system, markers may be placed at specific locations throughout the parking structure 110, any marker encoding that location's coordinates: latitude, longitude and height off the floor, and/or floor number, and the like. Further, measuring the visual angle from a vehicle's 102 device to the marker may enable the device to estimate its own location coordinates in reference to the marker. Coordinates include latitude, longitude, level and altitude off a given floor of the parking structure 110.

In one embodiment, the vehicle 102 may determine its location based on the one or more visual features. For example, a collection of successive snapshots from a vehicle 102 device's camera can build a database of images that is suitable for estimating location in the parking structure 110. In one embodiment, once the database is built or during the building of such a database, the vehicle 102 moving through the parking structure 110 may take snapshots that can be interpolated into the database, yielding location coordinates. These coordinates can be used in conjunction with other location techniques for higher accuracy of the location of the vehicle 102.

In various embodiments, an indoor positioning system (IPS) may be used in connection with the vehicle 102 and the parking structure 110 to determine the vehicle's position. In particular, an IPS may refer to a system to locate objects (e.g., the vehicle 102) inside a building such as a parking structure 110 using lights, radio waves, magnetic fields, acoustic signals, or other sensory information collected by mobile devices (e.g., user devices or vehicle devices). IPSes may use different technologies, including distance measurement to nearby anchor nodes (nodes with known fixed positions, e.g. WiFi and/or Li-Fi access points or Bluetooth beacons, magnetic positioning, and/or dead reckoning). Such IPSs may actively locate mobile devices and tags or provide ambient location or environmental context for devices to get sensed. In one embodiment, an IPS system may determine at least three independent measurements are to unambiguously find a location (see trilateration) of a given vehicle 102.

In one embodiment, Li-Fi may refer to a technology for wireless communication between devices (e.g., a vehicle's 102 device and a wireless communication device 116 in a parking structure 110) using light to transmit data and position. In one embodiment, a LED lamp can be used for the transmission of visible light. In one embodiment, the Li-Fi may be part of an optical wireless communications (OWC) technology in the parking structure 110 that may use light from light-emitting diodes (LEDs) as a medium to deliver networked, mobile, high-speed communication in a similar manner to Wi-Fi. In an aspect, Li-Fi may have the advantage of being useful in electromagnetic sensitive areas such as closed parking structures 110 without causing electromagnetic interference. In one embodiment, both Wi-Fi and Li-Fi transmit data over the electromagnetic spectrum, but whereas Wi-Fi utilizes radio waves, Li-Fi may use visible light, ultraviolet and/or infrared light.

In another embodiment, devices of the vehicle 102 may include one or more photodiodes that may receive signals from light sources. Moreover, the image sensor used in these vehicle 102 devices may include an array of photodiodes (pixels) and in some applications its use may be preferred over a single photodiode. Such a sensor may provide either multi-channel (down to 1 pixel=1 channel) or a spatial awareness of multiple light sources.

In another aspect, the environmental context 100 may include one or more satellites 130 and one or more cellular towers 132. In another embodiment, the vehicle 102 may include a transceiver, which may in turn may include one or more location receivers (e.g., GPS receivers) that may receive location signals (e.g., GPS signals) from one or more satellites 130. In another embodiment, a GPS receiver may refer to a device that can receive information from GPS satellites (e.g., satellites 130) and calculate the vehicle's 102 geographical position. Using suitable software, the vehicle may display the position on a map displayed on a human-machine interface (HMI), and the GPS receiver may offer information corresponding to navigational directions.

In one embodiment, GPS navigation services may be implemented based on the geographic position information of the vehicle provided by a GPS based chipset/component. A user of the vehicle 102 may enter a destination using inputs to an HMI including a display screen, and a route to a destination may be calculated based on the destination address and a current position of the vehicle determined at approximately the time of route calculation. In another embodiment, turn-by-turn (TBT) directions may further be provided on the display screen corresponding to the GPS component and/or through vocal directions provided through a vehicle audio component. In some implementations, the GPS based chipset component itself may be configured to determine that the vehicle 102 is about to enter a multi-level parking garage. For example, the GPS based chipset/component may execute software that includes the locations of all known multi-level parking garages and that issues a notification when the vehicle travels into one of the known multi-level parking garages.

In another embodiment, the location device may use GPS signals received from a global navigation satellite system (GNSS). In another embodiment, a user device 106 (e.g., a smart phone) may also have GPS capability that may be used in conjunction with the GPS receiver, for example, to increase the accuracy of calculating the vehicle's 102 geographical position. In particular, the user's device 106 may use assisted GPS (A-GPS) technology, which can use base station or cell towers 132 to provide a faster time to first fix (TTFF), for example, when GPS signals are poor or unavailable. In another embodiment, the GPS receiver may be connected to other electronic devices associated with the vehicle 102. Depending on the type of electronic devices and available connectors, connections can be made through a serial or universal service bus (USB) cable, as well as a Bluetooth connection, a compact flash connection, standard (SD) connection, personal computer memory card international association (PCMCIA) connection, an ExpressCard connection, and the like.

In various embodiments, the GPS receiver may be configured to use an L5 frequency band (e.g., centered at approximately 1176.45 MHz) for higher accuracy location determination (e.g., to pinpoint the vehicle 102 to approximately one foot accuracy). In another embodiment, the location device may include the capability to detect location signals from one or more non-GPS based systems, for example, to increase the location accuracy determination. For example, the location device may be configured to receive one or more location signals from a Russian global navigation satellite system (GLONASS), a Chinese BeiDou navigation satellite system, a European union Galileo positioning system, an Indian regional navigation satellite system (IRNSS), and/or a Japanese quasi-zenith satellite system, and the like.

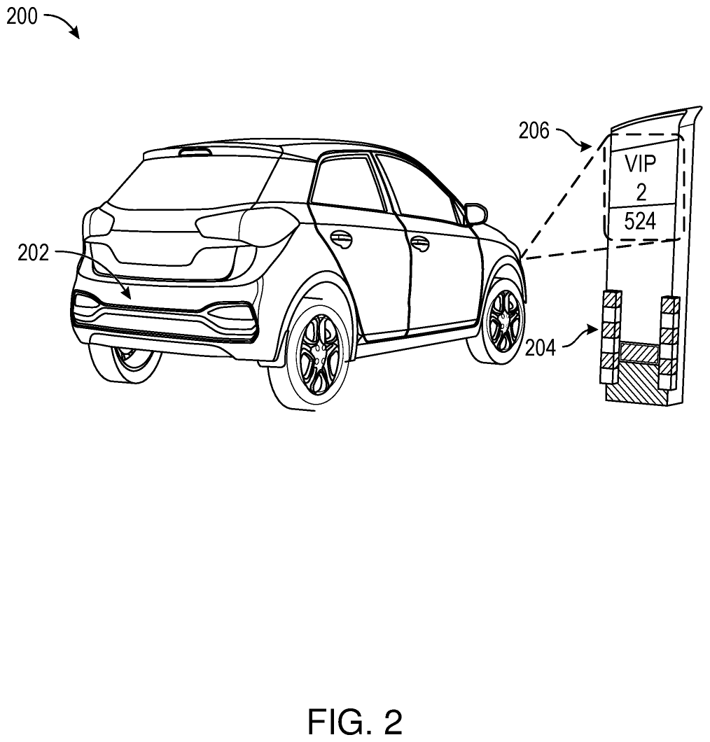

FIG. 2 shows a diagram of an example vehicle detecting landmarks while navigating a parking structure, in accordance with example embodiments of the disclosure. In one embodiment, diagram 200 includes a vehicle 202. In another embodiment, the vehicle 202 may include an autonomous vehicle (AV).

In another embodiment, diagram 200 includes an example of a landmark 204, for example, a column of a parking structure. In one embodiment, the landmark 204 may include a feature 206, for example, a sign having indicia indicative of a portion of the parking structure (e.g., a floor, a section, and the like). In another embodiment, the landmark 204 may be detected using an artificial-intelligence based algorithm, to be discussed further below.

In one example embodiment, when a combination of events occurs simultaneously or in succession, the vehicle 202 may determine that the vehicle 202 is in a parking garage (e.g., similar to parking garage 110, described in connection with FIG. 1, above) and being parked. For example, a vehicle's 202 speed may below a predetermined threshold (e.g., approximately 15 miles per hour) for a given duration of time (e.g., approximately 5 to 10 seconds), and one or more vehicle 202 devices (e.g., an accelerometer, a gyroscope, an inertial measurement unit, and the like) may have internal readings that indicate an incline or decline greater than a threshold value (e.g., approximately 10 degrees) is being experienced for a given duration of time (e.g., approximately 5 to 10 seconds). In such a situation, the vehicle's 202 front camera(s) (and/or a 360-degree field-of-view camera on certain vehicles) can be activated to record data, and an optical character recognition (OCR) algorithm may be used to read and analyze information from various features (e.g., feature 206) extracted from the images, for example, features corresponding to landmarks 204 posted signs or large characters of various floor levels as the vehicle 202 progresses upwards or downwards through the floors of a multi-level parking structure.

In one embodiment, once the vehicle 202 has stopped moving for a given duration of time (e.g., more than approximately 30 seconds), the last recorded landmark 204 information and/or one or more recorded images may be retained within an internal storage device associated with the vehicle 202. In an aspect, the stored information and/or images may be later used, in conjunction with additional information such as the vehicle's 202 last recorded GPS location, to determine the relative location of the vehicle 202 in the X, Y, and Z directions. Moreover, the relative location, along with the OCR produced information and/or landmark 204 images may be transmitted to a user's phone to allow users to identify surrounding objects and landmarks to aid with their search for the vehicle 202. Furthermore, one or more devices of the vehicle 202 (e.g., a display associated with the vehicle 202, not shown) may prompt a user to confirm the parking structure level via a human machine interface (HMI) in the vehicle, and/or a user device, in order to train the algorithms used in determining any of the above described features and thereby to help error-proof the system.

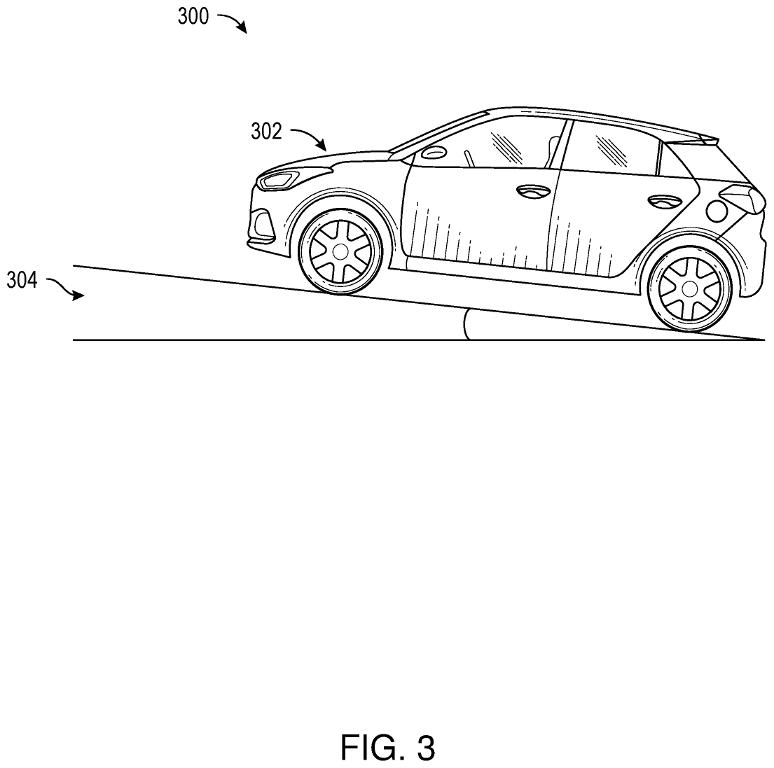

FIG. 3 shows a diagram of a vehicle navigating a parking structure, in accordance with example embodiments of the disclosure. In one embodiment, diagram 300 includes a vehicle 302. In another embodiment, the vehicle 302 may include an autonomous vehicle (AV). In one embodiment, diagram 300 shows the vehicle 302 having a given positional state 304. In particular, the given positional state 304 shown in diagram 300 includes the vehicle 302 having a given pitch (e.g., inclination) of approximately 10 degrees. This may be due to the vehicle 302 driving in a ramp of a parking structure (e.g., a parking structure similar to the parking structure 110 shown and described in connection with FIG. 1, above). In addition, the given positional state 304 may include the vehicle 302 having a declination (not shown), for example, for an underground parking structure and/or a parking structure having multiple levels, and may correspond to the vehicle 302 driving down a ramp of the parking structure (e.g., a parking structure similar to the parking structure 110 shown and described in connection with FIG. 1, above). In either case, or in any similar case, the positional state 304 may be determined using one or more devices of the vehicle 302, for example, an accelerometer or a gyroscope in the vehicle 302.

In one embodiment, the determination of the positional state 304 and/or a series of positional states of the vehicle 302 may include but may not be limited to determining a number of circles, or loops, traversed by the vehicle 302 while located in a multi-level parking structure. Determining the number of loops may comprise analyzing data provided from vehicle sensors that may include but are not limited to steering wheel sensors, wheel sensors, accelerometers, and vehicle speed sensors. In some implementations, determining the number of loops traversed by the vehicle 302 may comprise identifying repetitions in data produced from one or more sensors of the vehicle 302. For example, a repetition may be determined to be present only when repetitions are identified at corresponding locations in data provided from multiple vehicle sensors. In some implementations, the repetitions may be periodic or pseudo-periodic (e.g., basically periodic but having some noise and/or other artifacts that may be filtered out of the signal) in order to denote the traversal or a loop or circle by the vehicle 302.

In another embodiment, a level of a multilevel parking structure on which the vehicle 302 is parked may then be determined based on the number of loops traversed by the vehicle 302 upon entry into a multilevel parking structure. In some implementations, an integer may be added or subtracted from the number of loops traversed by the vehicle 302 to determine the level on which the vehicle 302 is parked in order to account for idiosyncrasies of the multilevel parking garage. For example, a database storing parking garage information may be queried in order to translate a number of loops traversed by the vehicle 302 to a parking garage level or floor.

Moreover, the directionality of the loops traversed may be determined. In determining the total number of loops traversed, the total number of loops traversed by may be decreased by subtracting the number of loops traversed in one direction from the number of loops traversed in an opposite direction. In some embodiments, the information displayed to the user may be accompanied with a request to the user to confirm the level of the parking garage on which the vehicle 302 is currently located. Further, in some aspects, a number of levels of ascent or descent recorded prior to the ignition of the vehicle 302 being turned off may be combined with a number of levels of ascent or descent recorded prior to a preceding ignition turn off event. For example, if a manual vehicle stalls as a result of operator error, the number of levels of ascent and descent occurring immediately prior to multiple ignition shut off events may be aggregated. Similarly, data recorded by vehicle 302 sensors immediately prior to an ignition turn off event may be combined with data recorded prior to a preceding vehicle 302 turn off event in order to determine the total number of levels of net ascent or descent within a multilevel parking garage.

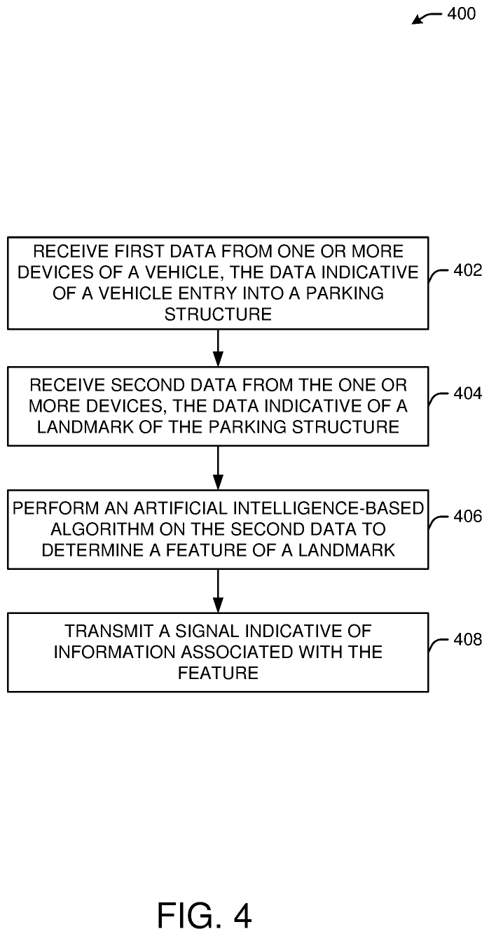

FIG. 4 shows an example process flow 400 for a method of vehicle location determination, in accordance with example embodiments of the disclosure. At block 402, first data may be received from one or more devices of a vehicle, the first data indicative of the vehicle's entry into a parking structure. In one embodiment, the first data may include data indicative of one or more of a change in a pitch of the vehicle, a change in a yaw of the vehicle, or a change in elevation of the vehicle. In another embodiment, the first data may include data from one or more of a wheel speed sensor, steering angle sensor, or an inertial sensor of the vehicle. In one embodiment, the first data may include data obtained from a sound associated with a gate for a parking structure, or other data corresponding to one or more events such as inserting a credit card into an automated teller machine, buying a ticket, a gate opening, and the like.

At block 404, second data may be received from the one or more devices of the vehicle, the second data indicative of a landmark associated with the parking structure and on a route taken by the vehicle. In one embodiment, second data may include data from a camera device, a radar device, a lidar device, or an ultrasound device of the vehicle, or the like. In another embodiment, landmark may include an elevator, a pillar, a wall, or a structure in view of an exit, or the like. In another embodiment, the landmark may include, for example, a column of a parking structure. In one embodiment, the landmark may include a feature, for example, a sign having indicia indicative of a portion of the parking structure (e.g., a floor, a section, and the like).

At block 406, an artificial intelligence-based algorithm may be performed on the second data to determine a feature of the landmark. In another embodiment, the feature includes a content of a sign, a color of a sign, a content of a ground marking associated with the landmark. In one embodiment, artificial intelligence-based algorithm includes an optical pattern recognition algorithm. Further, as noted, embodiments of devices and systems (and their various components) described herein can employ artificial intelligence (AI) to facilitate automating one or more features described herein. The components can employ various AI-based schemes for carrying out various embodiments and/or examples disclosed herein. To provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system, environment, etc. from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether the events are correlated in close temporal proximity, and whether the events and data come from one or several event and data sources (e.g., different sensor inputs). Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and/or probabilistic classification models providing different patterns of independence can be employed. Classification as used herein also is inclusive of statistical regression that is utilized to develop models of priority.

At block 408, a signal may be transmitted, the signal indicative of information associated with the feature. In one embodiment, the transmitted signal includes a wirelessly transmitted signal, such as a cellular signal, a WiFi-based signal, or the like. In another embodiment, the transmitted signal may be based at least in part on a park state signal provided by a remote park assist of the vehicle. In one embodiment, it may be determined that there was a failure of the signal to be received, and accordingly, a cellular data link with a device (e.g., a user's device) may be established.

In another embodiment, the wireless signal may be sent to a user's device. A user device may be configured to communicate with the one or more devices of the vehicle using one or more communications networks, wirelessly or wired. Any of the communications networks may include, but not limited to, any one of a combination of different types of suitable communications networks such as, for example, broadcasting networks, public networks (for example, the Internet), private networks, wireless networks, cellular networks, or any other suitable private and/or public networks. Further, any of the communications networks may have any suitable communication range associated therewith and may include, for example, global networks (for example, the Internet), metropolitan area networks (MANs), wide area networks (WANs), local area networks (LANs), or personal area networks (PANs). In addition, any of the communications networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

The user device may include one or more communications antennae. Communications antenna may be any suitable type of antenna corresponding to the communications protocols used by the user device and the devices of the vehicle. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user device.

The user devices may include any suitable radio and/or transceiver for transmitting and/or receiving radio frequency (RF) signals in the bandwidth and/or channels corresponding to the communications protocols utilized by any of the user device and/or the vehicle devices to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Typically, when a device of the vehicle establishes communication with a user device, the device of the vehicle may communicate in the downlink direction by sending data frames (e.g. a data frame which can comprise various fields such as a frame control field, a duration field, an address field, a data field, and a checksum field). The data frames may be preceded by one or more preambles that may be part of one or more headers. These preambles may be used to allow the user device to detect a new incoming data frame from the vehicle device. A preamble may be a signal used in network communications to synchronize transmission timing between two or more devices (e.g., between the vehicle device and user device).

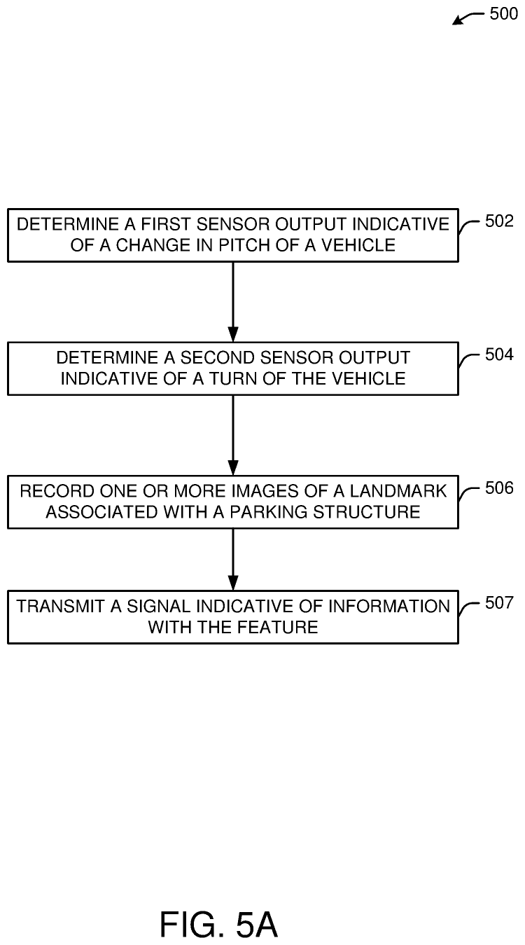

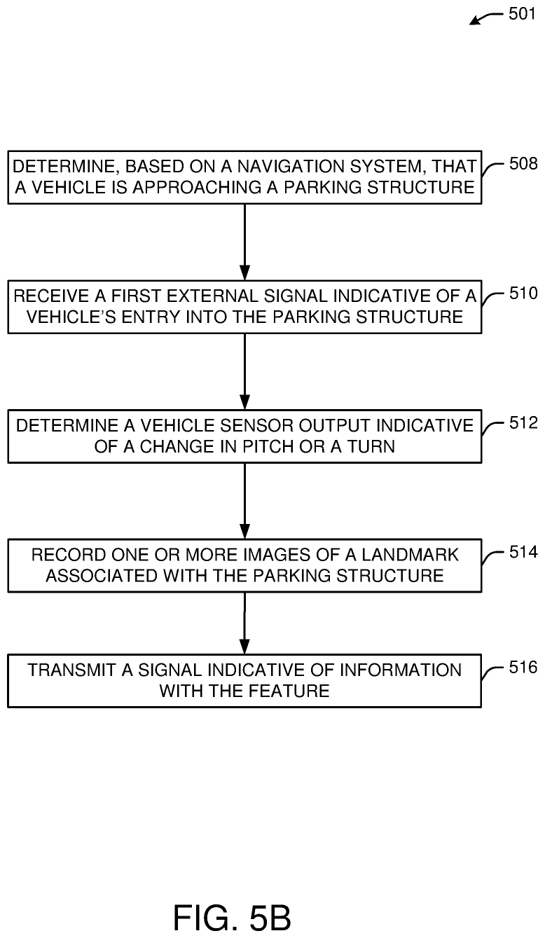

FIG. 5A shows another example process flow 500 for a method of vehicle location determination, in accordance with example embodiments of the disclosure. At block 502, a first sensor output may be determined, the first sensor output indicative of a change in pitch of the vehicle. At block 504, a second sensor output may be determined, the second sensor output indicative of a turn associated with the vehicle. As described in connection with FIG. 3, above, changes in pitch and/or turns may be considered changes in the positional state of the vehicle, and may be determined using one or more devices of the vehicle, such as accelerometers, gyroscopes, and the like. As noted, in one embodiment, the determining of the positional state and/or a series of positional states of the vehicle may include but may not be limited to determining a number of circles, or loops, traversed by the vehicle while located in a multi-level parking structure. Determining the number of loops may comprise comparing data provided from vehicle sensors that may include but are not limited to steering wheel sensors, wheel sensors, accelerometers, and vehicle speed sensors. In some implementations, determining the number of loops traversed by the vehicle may comprise identifying repetitions in data produced from one or more sensors. A repetition may be determined to be present only when repetitions are identified at corresponding locations in data provided from multiple vehicle sensors. In some implementations, the repetitions may be periodic or pseudo-periodic (e.g., basically periodic but having some noise and/or other artifacts that may be filtered out of the signal) in order to denote the traversal or a loop or circle by the vehicle. A level of a multilevel parking structure on which the vehicle is parked may then be determined based on the number of loops traversed by the vehicle upon entry into a multilevel parking structure.

At block 506, one or more images of landmark associated with the parking structure and on a route taken by the vehicle may be recorded, for example, by one or more devices of the vehicle. For example, as noted, the vehicle's front camera(s) (and/or a 360-degree field-of-view camera on certain vehicles) can be activated to record data, and an OCR algorithm may be used to read and analyze information from various features of the images, for example, features corresponding to posted signs or large characters of various floor levels as a vehicle progresses upwards or downwards through the floors of a multi-level parking structure. In one embodiment, once the vehicle has stopped moving for a given duration of time (e.g., more than approximately 30 seconds), the last recorded sign information and/or recorded images may be retained within an internal storage device associated with the vehicle. In an aspect, the stored information and/or images may be later used, in conjunction with additional information such as the vehicle's last recorded GPS location, to determine the relative location of the vehicle in the X, Y, and Z directions.

In another embodiment, the recording of the images may be triggered by a suitable action of the vehicle. For example, a prolonged period of a vehicle speed sensor determining that the speed of the vehicle is zero may be used as an indication of a parking state of the vehicle and may trigger a recoding of the images. In some implementations, this may trigger a vehicle device to begin recording data from one or more vehicle sensors, or may indicate to a given vehicle device to store a point in time at which the trigger was initiated as a reference point for future determinations (e.g., determining the total time that the vehicle was parked, which may be useful for contesting parking tickets).

At block 507, a signal may be transmitted to one or more devices, the signal indicative of information associated with the feature. In another embodiment, the signals may be transmitted wirelessly using any suitable protocol, including, but not limited to, cellular, Wi-Fi, Bluetooth, and the like, as described in connection with FIG. 4 (e.g., block 408). In another embodiment, the signal may include the images and/or video taken, or may include extracted information (e.g., textual descriptions) that are determined from the images and/or videos. The extracted information may be determined using an AI-based algorithm, as described above.

FIG. 5B shows another example process flow 501 for a method of vehicle location determination, in accordance with example embodiments of the disclosure. At block 508, it may be determined, based on a navigation system, that a vehicle is approaching a parking structure. In one embodiment, as noted, GPS navigation services may be implemented based on the geographic position information of the vehicle provided by a GPS based chipset/component. In some implementations, the GPS based chipset component itself may be configured to determine that the vehicle is about to enter a multi-level parking garage. For example, the GPS based chipset/component may execute software that includes the locations of all known multi-level parking garages and that issues a notification when the vehicle travels into one of the known multi-level parking garages.

At block 510, a first external signal indicative of a vehicle's entry into the parking structure may be received. In another aspect, the external signal may include an audio signal (e.g., a signal associated with a parking meter such as the issuance of a ticket). In another aspect, such a signal may be determined from a device associated with the parking structure itself, such as a Wi-Fi signal, a Bluetooth signal, a cellular signal, a beacon signal, or any other suitable external signal.

At block 512, a vehicle sensor output may be determined, the sensor output indicative of a change in pitch, a turn, or the like. In particular, in an embodiment, the vehicle may sense changes in garage level using one or more sensors and devices on the vehicle, for example, wheel speed sensors, a steering angle sensor, an inertial sensors, and the like to determine one or more of the following: pitch changes, turns, and/or position (via dead reckoning), combination thereof, or the like. Further, the determination of the change in pitch, a turn, or the like may be determined as described in various aspects of the disclosure (e.g., see FIG. 3 and related description), above.

At block 514, one or more images of landmark may be recorded, the landmark associated with the parking structure and on a route taken by the vehicle. As noted, in various embodiments, one or more pattern recognition algorithms may be used in association with data from originating from the vehicle's devices such as the vehicle's cameras, radio detection and ranging (radar), light detection and ranging (lidar), and/or ultrasound, in order to identify and store images of landmarks and features of the parking garage such as elevators, pillars, walls, structures in view of exterior openings and the like.

At block 516, a signal may be transmitted, the signal indicative of information associated with the feature. As noted, one or more algorithms, for example, sign recognition and/or optical character recognition (OCR) algorithms may be used to recognize and read various features such as floor number and colors associated with signs in the parking garage, and/or to recognize and read features from paint marks on the ground. Moreover, the algorithms may be used to determine when to store a picture of a sign (e.g., upon the determination of a given feature of a parking garage). In one embodiment, one or more devices associated with the vehicle may be configured to transmit images to a phone while wirelessly connected to a phone. For example, the devices may configured to transmit images of particular images (e.g., those having a given features such as a number associated with floor number) and/or images captured within a particular time before the vehicle was parked.

In one embodiment, if the vehicle is unable to transmit the parking images and data to the phone upon parking, the user may be able to establish a an alternative communication with the vehicle (e.g., via a cellular data interface) in order for the user to access one or more images (e.g., landmark images) and/or parking structure level information (e.g., determined by one or more algorithms using the images or other data from devices on the vehicle) from the vehicle as available by using a user device.

In various aspects, one or more user devices associated with either the driver or passengers of the vehicle may include sensors that can be used to supplement information determined by the vehicle and associated devices. For example, in one embodiment, the vehicle may include a magnetometer or a barometer, in part, to determine an elevation or altitude of the vehicle. The vehicle and associated devices may employ sensor fusion to determine a parking activity. For example, a combination of sensor outputs may be analyzed by a computing module on the vehicle that simultaneously or successively indicate certain thresholds have been met to determine a parking activity. The vehicle and associated devices (e.g., cameras, lidar, radar and the like) may determine a gate associated with entry to a parking garage. In another embodiment, the vehicle and associated devices may upload information and/or images to a cloud-based network. In one embodiment, the vehicle and associated devices, and/or one or more user devices (e.g., a driver device or a passenger device) may be configured to detect and communicate with an IPS, as described above.

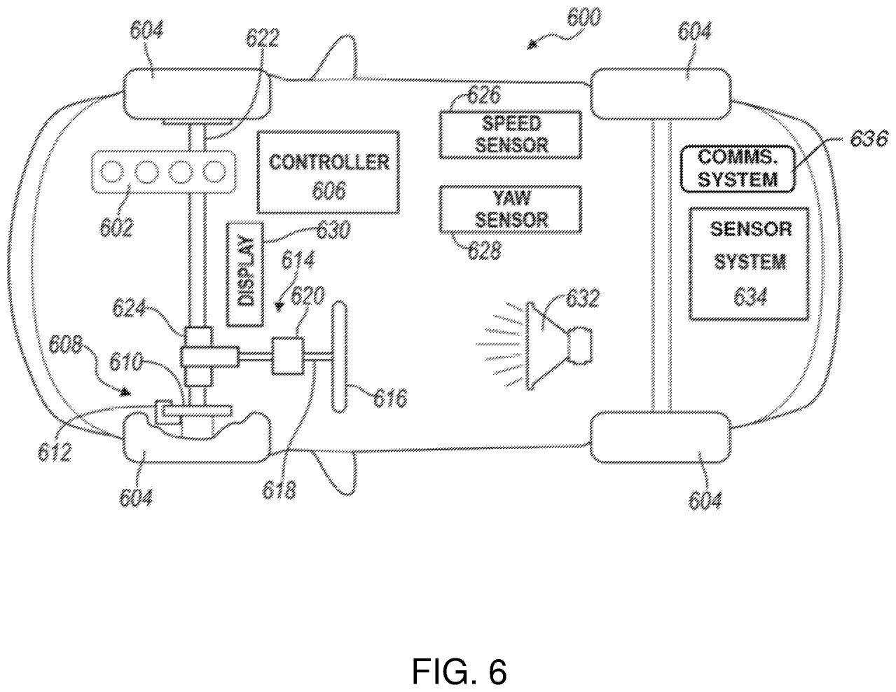

FIG. 6 is a schematic illustration of an example autonomous vehicle in accordance with one or more embodiments of the disclosure. As noted, the vehicle (e.g., vehicle 102 or 202 shown and described in connection with FIGS. 1 and 2, above), may include an autonomous vehicle. Referring to FIG. 6, an example autonomous vehicle 600 may include a power plant 602 (such as a combustion engine and/or an electric motor) that provides torque to driven wheels 604 that propel the vehicle forward or backward.

Autonomous vehicle operation, including propulsion, steering, braking, navigation, and the like, may be controlled autonomously by a vehicle controller 606. For example, the vehicle controller 606 may be configured to receive feedback from one or more sensors (e.g., sensor system 634, etc.) and other vehicle components to determine road conditions, vehicle positioning, and so forth. The vehicle controller 606 may also ingest data form various sensors such as speed monitor and yaw sensor, as well as the tires, brakes, motor, and other vehicle components. The vehicle controller 606 may use the feedback and route/map data of the route to determine actions to be taken by the autonomous vehicle, which may include operations related to the engine, steering, braking, and so forth. Control of the various vehicle systems may be implemented using any suitable mechanical means, such as servo motors, robotic arms (e.g., to control steering wheel operation, acceleration pedal, brake pedal, etc.), and so forth. The controller 606 may be configured to process the route data for a neighborhood tour, and may be configured to interact with the user via the user interface devices in the car and/or by communicating with the user's user device.

The vehicle controller 606 may include one or more computer processors coupled to at least one memory. The vehicle 600 may include a braking system 608 having disks 610 and calipers 612. The vehicle 600 may include a steering system 614. The steering system 614 may include a steering wheel 616, a steering shaft 618 interconnecting the steering wheel to a steering rack 620 (or steering box). The front and/or rear wheels 604 may be connected to the steering rack 620 via axle 622. A steering sensor 624 may be disposed proximate the steering shaft 618 to measure a steering angle. The vehicle 600 also includes a speed sensor 626 that may be disposed at the wheels 604 or in the transmission. The speed sensor 626 is configured to output a signal to the controller 606 indicating the speed of the vehicle. A yaw sensor 628 is in communication with the controller 606 and is configured to output a signal indicating the yaw of the vehicle 600.

The vehicle 600 includes a cabin having a display 630 in electronic communication with the controller 606. The display 630 may be a touchscreen that displays information to the passengers of the vehicle and/or functions as an input, such as whether or not the rider is authenticated. A person having ordinary skill in the art will appreciate that many different display and input devices are available and that the present disclosure is not limited to any particular display. An audio system 632 may be disposed within the cabin and may include one or more speakers for providing information and entertainment to the driver and/or passengers. The audio system 632 may also include a microphone for receiving voice inputs. The vehicle may include a communications system 636 that is configured to send and/or receive wireless communications via one or more networks. The communications system 636 may be configured for communication with devices in the car or outside the car, such as a user's device, other vehicles, etc.

The vehicle 600 may also include a sensor system for sensing areas external to the vehicle, such as parking structures (shown and described in connection with FIG. 1, above). The sensor system may include a plurality of different types of sensors and devices such as cameras, ultrasonic sensors, radar, lidar, and/or combinations thereof. The sensor system may be in electronic communication with the controller 606 for controlling the functions of various components. The controller may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “look up tables” that are based on calculations and test data, and are stored within the memory. The controller may communicate with other vehicle systems and controllers over one or more wired or wireless vehicle connections using common bus protocols (e.g., CAN and LIN). Used herein, a reference to “a controller” refers to one or more controllers and/or computer processors. The controller 606 may receive signals from the sensor system 634 and may include memory containing machine-readable instructions for processing the data from the sensor system. The controller 606 may be programmed to output instructions to at least the display 630, the audio system 632, the steering system 614, the braking system 608, and/or the power plant 602 to autonomously operate the vehicle 600.

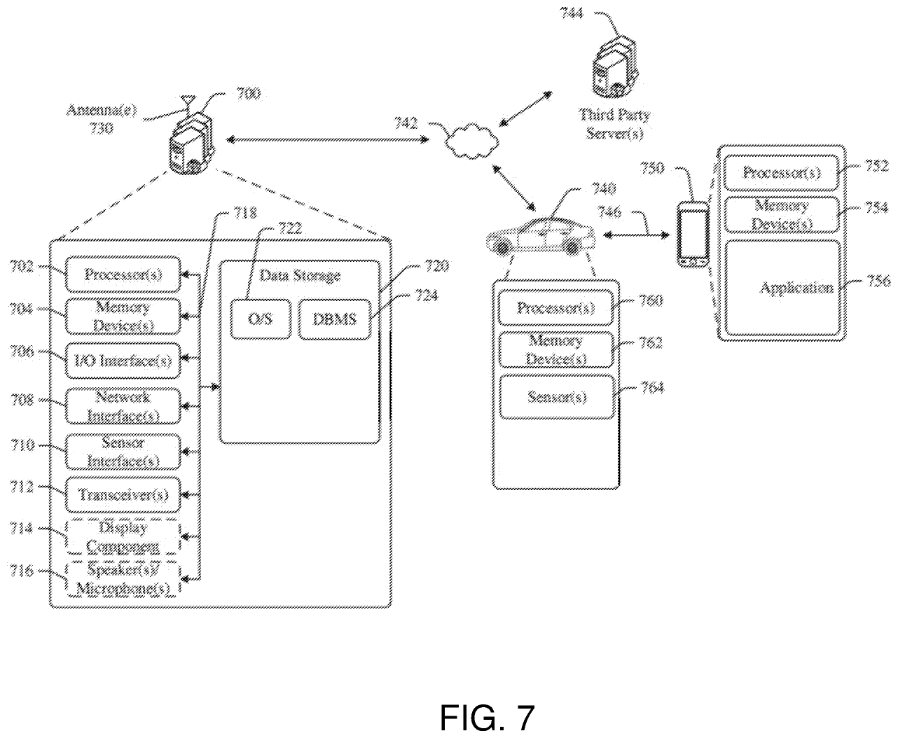

FIG. 7 is a schematic illustration of an example server architecture for one or more server(s) 700 in accordance with one or more embodiments of the disclosure. The server 700 illustrated in the example of FIG. 7 may correspond to a server that may be used by a vehicle (e.g., vehicle 102 as shown and described in connection with FIG. 1, above) on a network associated with the vehicle or a user device, including those associated with a parking structure and related devices (e.g., APs, Li-Fi devices, and the like). In an embodiment, the server 700 may include a cloud-based server that may serve to store and transmit information (e.g., images and video of a parking structure and associated feature of parking structure landmarks). Some or all of the individual components may be optional and/or different in various embodiments. In some embodiments, at least one of the servers described FIG. 7 may be located at an autonomous vehicle.

The server 700 may be in communication with a vehicle 740 (e.g., an autonomous vehicle), and one or more user devices 750. The vehicle 740 may be in communication with the one or more user devices 750. Further, the server 700, the vehicle 740, and/or the user devices 750 may be configured to communicate via one or more networks 742. The vehicle 740 may additionally be in wireless communication over one or more network(s) 742 with the user devices 750 via a connection protocol such as Bluetooth or Near Field Communication. Such network(s) 742 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the server 700 may include one or more processors (processor(s)) 702, one or more memory devices 704 (also referred to herein as memory 704), one or more input/output (I/O) interface(s) 706, one or more network interface(s) 708, one or more sensor(s) or sensor interface(s) 710, one or more transceiver(s) 712, one or more optional display components 714, one or more optional speakers(s)/camera(s)/microphone(s) 716, and data storage 720. The server 700 may further include one or more bus(es) 718 that functionally couple various components of the server 700. The server 700 may further include one or more antenna(e) 730 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 718 may include at least one of a system bus, a memory bus, an address bus, or a message bus, and may permit the exchange of information (e.g., data (including computer-executable code), signaling, etc.) between various components of the server 700. The bus(es) 718 may include, without limitation, a memory bus or a memory controller, a peripheral bus, an accelerated graphics port, and so forth. The bus(es) 718 may be associated with any suitable bus architecture.

The memory 704 of the server 700 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

The data storage 720 may include removable storage and/or non-removable storage including, but not limited to, magnetic storage, optical disk storage, and/or tape storage. The data storage 720 may provide non-volatile storage of computer-executable instructions and other data.

The data storage 720 may store computer-executable code, instructions, or the like that may be loadable into the memory 704 and executable by the processor(s) 702 to cause the processor(s) 702 to perform or initiate various operations. The data storage 720 may additionally store data that may be copied to the memory 704 for use by the processor(s) 702 during the execution of the computer-executable instructions. More specifically, the data storage 720 may store one or more operating systems (O/S) 722; one or more database management systems (DBMS) 724; and one or more program module(s), applications, engines, computer-executable code, scripts, or the like. Some or all of these component(s) may be sub-component(s). Any of the components depicted as being stored in the data storage 720 may include any combination of software, firmware, and/or hardware. The software and/or firmware may include computer-executable code, instructions, or the like that may be loaded into the memory 704 for execution by one or more of the processor(s) 702. Any of the components depicted as being stored in the data storage 720 may support functionality described in reference to corresponding components named earlier in this disclosure.

The processor(s) 702 may be configured to access the memory 704 and execute the computer-executable instructions loaded therein. For example, the processor(s) 702 may be configured to execute the computer-executable instructions of the various program module(s), applications, engines, or the like of the server 700 to cause or facilitate various operations to be performed in accordance with one or more embodiments of the disclosure. The processor(s) 702 may include any suitable processing unit capable of accepting data as input, processing the input data in accordance with stored computer-executable instructions, and generating output data. The processor(s) 702 may include any type of suitable processing unit.

Referring now to other illustrative components depicted as being stored in the data storage 720, the O/S 722 may be loaded from the data storage 720 into the memory 704 and may provide an interface between other application software executing on the server 700 and the hardware resources of the server 700.

The DBMS 724 may be loaded into the memory 704 and may support functionality for accessing, retrieving, storing, and/or manipulating data stored in the memory 704 and/or data stored in the data storage 720. The DBMS 724 may use any of a variety of database models (e.g., relational model, object model, etc.) and may support any of a variety of query languages.

Referring now to other illustrative components of the server 700, the input/output (I/O) interface(s) 706 may facilitate the receipt of input information by the server 700 from one or more I/O devices as well as the output of information from the server 700 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. The I/O interface(s) 706 may also include a connection to one or more of the antenna(e) 730 to connect to one or more networks via a wireless local area network (WLAN) (such as Wi-Fi) radio, Bluetooth, ZigBee, and/or a wireless network radio, such as a radio capable of communication with a wireless communication network such as a Long Term Evolution (LTE) network, WiMAX network, 3G network, a ZigBee network, etc.

The server 700 may further include one or more network interface(s) 708 via which the server 700 may communicate with any of a variety of other systems, platforms, networks, devices, and so forth. The network interface(s) 708 may enable communication, for example, with one or more wireless routers, one or more host servers, one or more web servers, and the like via one or more networks.

The sensor(s)/sensor interface(s) 710 may include or may be capable of interfacing with any suitable type of sensing device such as, for example, inertial sensors, force sensors, thermal sensors, photocells, and so forth.

The display component(s) 714 may include one or more display layers, such as LED or LCD layers, touch screen layers, protective layers, and/or other layers. The optional camera(s) of the speakers(s)/camera(s)/microphone(s) 716 may be any device configured to capture ambient light or images. The optional microphone(s) of the speakers(s)/camera(s)/microphone(s) 716 may be any device configured to receive analog sound input or voice data. The microphone(s) of the speakers(s)/camera(s)/microphone(s) 716 may include microphones used to capture sound.

It should be appreciated that the program module(s), applications, computer-executable instructions, code, or the like depicted in FIG. 7 as being stored in the data storage 720 are merely illustrative and not exhaustive and that processing described as being supported by any particular module may alternatively be distributed across multiple module(s) or performed by a different module.

It should further be appreciated that the server 700 may include alternate and/or additional hardware, software, or firmware components beyond those described or depicted without departing from the scope of the disclosure.

The user device 750 may include one or more computer processor(s) 752, one or more memory devices 754, and one or more applications, such as a vehicle application 756. Other embodiments may include different components.

The processor(s) 752 may be configured to access the memory 754 and execute the computer-executable instructions loaded therein. For example, the processor(s) 752 may be configured to execute the computer-executable instructions of the various program module(s), applications, engines, or the like of the device to cause or facilitate various operations to be performed in accordance with one or more embodiments of the disclosure. The processor(s) 752 may include any suitable processing unit capable of accepting data as input, processing the input data in accordance with stored computer-executable instructions, and generating output data. The processor(s) 752 may include any type of suitable processing unit.

The memory 754 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

Referring now to functionality supported by the user device 750, the autonomous vehicle application 756 may be a mobile application executable by the processor 752 that can be used to present options and/or receive user inputs of information related to the disclosed embodiments. In addition, the user device 750 may communicate with the vehicle 740 via the network 742 and/or a direct connect, which may be a wireless or wired connection. The user device 750 may include a camera, scanner, bio reader or the like to capture biometric data of a user, perform certain processing step on the biometric date, such as extracting features from captures biometric data, and then communicated those extracted features to one or more remote servers, such as one or more of cloud-based servers.

It should be appreciated that the program module(s), applications, computer-executable instructions, code, or the like depicted in FIG. 7 as being stored in the data storage 720 are merely illustrative and not exhaustive and that processing described as being supported by any particular module may alternatively be distributed across multiple module(s) or performed by a different module.

It should further be appreciated that the server 700 may include alternate and/or additional hardware, software, or firmware components beyond those described or depicted without departing from the scope of the disclosure.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Example embodiments of the disclosure may include one or more of the following examples:

Example 1 may include a device, comprising: at least one memory comprising computer-executable instructions; and one or more computer processors configured to access the at least one memory and execute the computer-executable instructions to: receive first data from one or more devices of a vehicle, the first data indicative of the vehicle being in a parking structure; receive second data from the one or more devices of the vehicle, the second data indicative of a landmark associated with the parking structure; determine, based on the second data, a feature of the landmark; and cause to transmit a signal indicative of information associated with the feature.

Example 2 may include the device of example 1, wherein the first data comprises data indicative of one or more of a change in a pitch of the vehicle, a change in a yaw of the vehicle, or a change in elevation of the vehicle.

Example 3 may include the device of example 1 and/or some other example herein, wherein the first data comprises data from one or more of a wheel speed sensor, steering angle sensor, or an inertial sensor of the vehicle.

Example 4 may include the device of example 1 and/or some other example herein, wherein second data comprises data from a camera device, a radio detection and ranging (radar) device, a light detection and ranging (lidar) device, or an ultrasound device of the vehicle.

Example 5 may include the device of example 1 and/or some other example herein, wherein the landmark includes an elevator, a pillar, a wall, or a structure in view of an exit.

Example 6 may include the device of example 1 and/or some other example herein, wherein the feature includes a content of a sign, a color of a sign, or a content of a ground marking associated with the landmark.

Example 7 may include the device of example 1 and/or some other example herein, wherein the determining, based on the second data, a feature of the landmark includes using an artificial intelligence-based algorithm on the second data to determine the feature of the landmark.

Example 8 may include the device of example 7 and/or some other example herein, wherein, the artificial intelligence-based algorithm includes an optical pattern recognition algorithm.

Example 9 may include the device of example 1 and/or some other example herein, wherein the transmitted signal is based at least in part on a park state signal provided by a remote park assist of the vehicle.

Example 10 may include the device of example 1 and/or some other example herein, wherein the one or more computer processors are further configured to access the at least one memory to: receive a signal indicative of a failure of the signal to be received, and cause to establish a cellular data link with a second device.

Example 11 may include a method, comprising: receiving, by a processor, first data from one or more devices of a vehicle, the first data indicative of the vehicle being in a parking structure; receiving, by the processor, second data from the one or more devices of the vehicle, the second data indicative of a landmark associated with the parking structure; determining, by the processor, based on the second data, a feature of the landmark; and causing to transmit, by the processor, a signal indicative of information associated with the feature.

Example 12 may include the method of example 11, wherein the first data comprises data indicative of one or more of a change in a pitch of the vehicle, a change in a yaw of the vehicle, or a change in elevation of the vehicle.

Example 13 may include the method of example 11 and/or some other example herein, wherein the first data comprises data from one or more of a wheel speed sensor, steering angle sensor, or an inertial sensor of the vehicle.

Example 14 may include the method of example 11 and/or some other example herein, wherein the second data comprises data from a camera device, a radar device, a lidar device, or an ultrasound device of the vehicle.

Example 15 may include the method of example 11 and/or some other example herein, wherein the landmark includes an elevator, a pillar, a wall, or a structure in view of an exit.

Example 16 may include the method of example 11 and/or some other example herein, wherein the feature includes a content of a sign, a color of a sign, or a content of a ground marking associated with the landmark.

Example 17 may include the method of example 11 and/or some other example herein, wherein the transmitted signal is based at least in part on a park state signal provided by a remote park assist of the vehicle.

Example 18 may include a non-transitory computer-readable medium storing computer-executable instructions which, when executed by a processor, cause the processor to perform operations comprising: receiving, by the processor, first data from one or more devices of a vehicle, the first data indicative of the vehicle being in a parking structure; receiving, by the processor, second data from the one or more devices of the vehicle, the second data indicative of a landmark associated with the parking structure; determining, by the processor, based on the second data, a feature of the landmark; and causing, by the processor, to transmit a signal indicative of information associated with the feature.

Example 19 may include the non-transitory computer-readable medium of example 18, wherein the first data comprises data indicative of one or more of a change in a pitch of the vehicle, a change in a yaw of the vehicle, or a change in elevation of the vehicle.

Example 20 may include the non-transitory computer-readable medium of example 18 and/or some other example herein, wherein he first data comprises data from one or more of a wheel speed sensor, steering angle sensor, or an inertial sensor of the vehicle, and wherein the second data comprises data from a camera device, a radar device, a lidar device, or an ultrasound device of the vehicle.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

What is claimed is:

1. A device comprising:
at least one memory comprising computer-executable instructions; and
one or more computer processors configured to access the at least one memory and execute the computer-executable instructions to:
receive first data from one or more devices of a vehicle, the first data indicative of the vehicle being in a parking structure;
receive second data from the one or more devices of the vehicle, the second data indicative of a landmark associated with the parking structure;
determine, based on the second data, a feature of the landmark; and
cause to transmit a signal indicative of information associated with the feature.

2. The device of claim 1, wherein the first data comprises data indicative of one or more of a change in a pitch of the vehicle, a change in a yaw of the vehicle, or a change in elevation of the vehicle.

3. The device of claim 1, wherein the first data comprises data from one or more of a wheel speed sensor, steering angle sensor, or an inertial sensor of the vehicle.

4. The device of claim 1, wherein second data comprises data from a camera device, a radio detection and ranging (radar) device, a light detection and ranging (lidar) device, or an ultrasound device of the vehicle.

5. The device of claim 1, wherein the landmark includes an elevator, a pillar, a wall, or a structure in view of an exit.

6. The device of claim 1, wherein the feature includes a content of a sign, a color of a sign, or a content of a ground marking associated with the landmark.

7. The device of claim 1, wherein the determining, based on the second data, a feature of the landmark includes using an artificial intelligence-based algorithm on the second data to determine the feature of the landmark.

8. The device of claim 7, wherein the artificial intelligence-based algorithm includes an optical pattern recognition algorithm.

9. The device of claim 1, wherein the transmitted signal is based at least in part on a park state signal provided by a remote park assist of the vehicle.

10. The vehicle of claim 1, wherein the one or more computer processors are further configured to access the at least one memory to: receive a signal indicative of a failure of the signal to be received, and cause to establish a cellular data link with a second device.

11. A method, comprising:
receiving, by a processor, first data from one or more devices of a vehicle, the first data indicative of the vehicle being in a parking structure;
receiving, by the processor, second data from the one or more devices of the vehicle, the second data indicative of a landmark associated with the parking structure;
determining, by the processor, based on the second data, a feature of the landmark; and
causing to transmit, by the processor, a signal indicative of information associated with the feature.

12. The method of claim 11, wherein the first data comprises data indicative of one or more of a change in a pitch of the vehicle, a change in a yaw of the vehicle, or a change in elevation of the vehicle.

13. The method of claim 11, wherein the first data comprises data from one or more of a wheel speed sensor, steering angle sensor, or an inertial sensor of the vehicle.

14. The method of claim 11, wherein second data comprises data from a camera device, a radar device, a lidar device, or an ultrasound device of the vehicle.

15. The method of claim 11, wherein the landmark includes an elevator, a pillar, a wall, or a structure in view of an exit.

16. The method of claim 11, wherein the feature includes a content of a sign, a color of a sign, or a content of a ground marking associated with the landmark.

17. The method of claim 11, wherein the transmitted signal is based at least in part on a park state signal provided by a remote park assist of the vehicle.

18. A non-transitory computer-readable medium storing computer-executable instructions which, when executed by a processor, cause the processor to perform operations comprising:
receiving, by the processor, first data from one or more devices of a vehicle, the first data indicative of the vehicle being in a parking structure;
receiving, by the processor, second data from the one or more devices of the vehicle, the second data indicative of a landmark associated with the parking structure;
determining, by the processor, based on the second data, a feature of the landmark; and
causing, by the processor, to transmit a signal indicative of information associated with the feature.

19. The non-transitory computer-readable medium of claim 18, wherein the first data comprises data indicative of one or more of a change in a pitch of the vehicle, a change in a yaw of the vehicle, or a change in elevation of the vehicle.

20. The non-transitory computer-readable medium of claim 18, wherein the first data comprises data from one or more of a wheel speed sensor, steering angle sensor, or an inertial sensor of the vehicle, and wherein the second data comprises data from a camera device, a radar device, a lidar device, or an ultrasound device of the vehicle.
